(19) United States
(12) Patent Application Publication
(10) Pub. No.: US 2024/0183999 A1
(43) Pub. Date: Jun. 6, 2024

(54) DOSIMETER APPARATUS AND METHODS

(71) Applicant: SYMETRICA LTD, North Baddesley, Southampton (GB)

(72) Inventor: David RAMSDEN, Southampton, Hampshire (GB)

(73) Assignee: SYMETRICA LTD, North Baddesley, Southampton (GB)

(21) Appl. No.: 18/547,532

(22) PCT Filed: Feb. 25, 2022
(86) PCT No.: PCT/GB2022/050520

§ 371 Date: Aug. 23, 2023

(30) Foreign Application Priority Data
Mar. 3, 2021 (GB) 2102987.1

(51) Int. Cl. G01T 1/02; G01T 1/20

(52) U.S. Cl. CPC G01T 1/023; G01T 1/20181; G01T 1/20182

(57) ABSTRACT

A dosimeter for characterising a spatial distribution of a radiation dose in a sensing region, the dosimeter comprising; a plurality of scintillation fibres extending substantially parallel to a first direction in the sensing region and arranged in a two-dimensional array in a plane perpendicular to the first direction, wherein the radiation absorption properties of the plurality of scintillation fibres are configured to approximate the radiation absorption properties of human body tissue; and a photodetector comprising a plurality of photodetector regions coupled to respective ones of the plurality of scintillation fibres so as to generate signals for respective ones of the photodetector regions in response to radiation interaction events in corresponding ones of the scintillation fibres; further comprising a controller arranged to receive the signals from the photodetector regions and to determine a spatial distribution of a radiation dose in the sensing region.

### FIELD

The present disclosure relates to dosimeter apparatus and methods for characterising the spatial distribution of a radiation dose.

### BACKGROUND

Radiation therapy (also known as radiotherapy) refers to approaches in which ionizing radiation is used for the treatment of pathologies such as cancerous tumours and/or lesions in the human or animal body. During radiation therapy, ionizing radiation, for example in the form of X-rays or accelerated charged particles, is generally delivered to the site of a tumour in order to induce cell death in cancerous cells. Intensity modulated radiation therapy (IMRT) and particle therapy are two radiotherapy modalities which may be used for the treatment of cancerous tumours. IMRT generally uses X-rays or gamma rays to deliver the radiation dose, and particle therapy uses charged particles such as protons to deliver the radiation dose. In the case of IMRT, a linear accelerator (LINAC) is generally used to generate one or more beams of X-rays which are directed into the body of the patient in order to target the site(s) of one or more tumours. In the case of proton therapy, which is the most well-known modality of charged particle therapy, protons are generated by a source such as an isochronous cyclotron, synchrotron or linear accelerator, and directed into the body in the form of one or more beams (for example, one or more pencil beams) to target the site(s) of one or more tumours (for example, extended or multiple tumours). Charged particle therapies, such as proton therapy, typically make use of the Bragg characteristics of accelerated charged particles in matter. Because the energy loss of charged particles in matter is inversely proportional to the square of their velocity, the maximum deposition of energy by a charged particle travelling through matter occurs just before it reaches a complete stop. Accordingly, the accelerating potential of a beam of protons can be selected in order to target the peak radiation dose at a predetermined depth in the body, wherein the depth is typically selected to corresponding to the site of a tumour to be treated. FIG. 1 schematically shows a radiotherapy configuration in which a proton beam 1 is directed towards the head 2 of a patient in order to deliver a dose of radiation to a treatment site 3, which typically comprises a region of cancerous tissue such as a tumour. As schematically indicated in FIG. 1, the energy of the proton beam is ideally selected such that a significant number (which may be substantially all) the protons come to rest and/or deposit the majority of their energy in the vicinity of a predetermined treatment site 3. The appropriate acceleration potential of the beam can be determined in a treatment planning phase (as described further herein) using 2D/3D image data of the treatment site and surrounding tissues (e.g. derived from computed tomography), and knowledge of the Bragg characteristics of the proton beam. This approach may be considered advantageous as it reduces the deposition of energy in regions of healthy tissue outside the treatment site 3. This is illustrated schematically in FIG. 1, in which substantially all the protons in beam 1 come to rest in the vicinity of treatment site 3, and there is not a significant exit beam extending beyond the treatment site.

Because the use of ionizing radiation in the human body has the potential to cause damage to healthy tissue (e.g. along portions of a beam path preceding and following the treatment site), delivery of radiotherapy to a patient is preceded by a treatment planning phase, in which the radiation beam parameters (for example, accelerating potential and beam geometry), the directions of beam entry to the body, and the dose delivery periods are calculated to deliver a dose of radiation to one or more tumours which is determined to be suitable to provide the required therapeutic effect, whilst minimizing the radiation dose to healthy tissues in the patient. Treatment planning is generally conducted by using three-dimensional (3D) image data obtained from 3D X-ray computed tomography (XCT) and/or 3D magnetic resonance imaging and/or proton radiography and/or 3D proton computed tomography of the patient (for example, using X-ray imaging data calibrated using proton imaging data to account for the different ways X-rays and protons interact with bodily tissues). These data enable visualization of the 3D distribution of different tissues within the patient's body, such as for instance tumour, muscle, fat, bony structures, and organs. Information about the 3D distribution of tissues within the body can be used in conjunction with calculations of radiation absorption characteristics in different tissues to determine via computer-aided approaches (such as computerised simulation) a dose intensity pattern that is suitable for treating the tumour. Typically, in radiotherapy, combinations of multiple intensity-modulated radiation beams directed towards the tumour site from different orientations are used to produce a customized radiation dose distribution within the body which maximizes the received dose within the tissues of one or more tumours while minimizing the dose to normal tissues adjacent the tumour(s). The output of the treatment planning phase is a protocol for the delivery of radiation to the patient, commonly termed a treatment plan, which may comprise information about the intensities and shapes of the beams to be used, the orientations at which they are to be directed at the body, the accelerating potential of the beams, and the duration for which the body is to be exposed to each beam.

Because of the importance of delivering a radiation dose to the correct site within the body during radiotherapy treatment, there is a desire to develop approaches which allow a treatment plan to be verified before it is applied to the body of the patient, ensuring that the spatial distribution of the radiation dose planned during the treatment planning phase corresponds with the spatial distribution of the actual dose delivered by the radiotherapy apparatus. Various approaches are described herein which seek to help address or mitigate at least some of the issues discussed above.

### SUMMARY

In accordance with a first embodiment of the present disclosure there is provided a dosimeter for characterising a spatial distribution of a radiation dose in a sensing region, the dosimeter comprising; a plurality of scintillation fibres extending substantially parallel to a first direction in the sensing region and arranged in a two-dimensional array in a plane perpendicular to the first direction; and a photodetector comprising a plurality of photodetector regions coupled to respective ones of the plurality of scintillation fibres so as to generate signals for respective ones of the photodetector regions in response to radiation interaction events in corresponding ones of the scintillation fibres; further comprising a controller arranged to receive the signals from the photodetector regions and to determine a spatial distribution of a radiation dose in the sensing region based on the extent to which the signals from the plurality of photodetector regions indicate there have been radiation interaction events in different ones of the plurality of scintillation fibres.

In accordance with some embodiments, a plurality of parallel scintillation fibres are arranged in a plurality of stacked layers.

In accordance with some embodiments, each layer of scintillation fibres in the plurality of stacked layers comprises a pre-fabricated mat of scintillation fibres, wherein the scintillation fibres within each mat are oriented in the same direction, and the mats are bonded together to form the plurality of stacked layers.

In accordance with some embodiments the scintillation fibres have a width of between 0.5 mm and 3 mm.

In accordance with some embodiments, the scintillation fibres have a square cross-section. In accordance with some embodiments, the radiation absorption properties of the plurality of scintillation fibres are configured to approximate (i.e. to match) the radiation absorption properties of human body tissue. In some other embodiments, this is not the case and the radiation absorption properties of the plurality of scintillation fibres will not be configured to approximate (i.e. to match) the radiation absorption properties of human body tissue.

In accordance with some embodiments, a fibre optic faceplate is disposed between the plurality of scintillation fibres and the plurality of photodetector regions.

In accordance with some embodiments a filter is disposed between the plurality of scintillation fibres and the plurality of photodetector regions.

In accordance with some embodiments each of the plurality of scintillation fibres comprises a first end coupled to the photodetector and a second end distal to the first end, and the dosimeter comprises one or more reflective elements arranged to reflect signals emitted from the second end of each of the scintillation fibres back towards the first end.

In accordance with some embodiments, the dosimeter comprises a drive mechanism arranged to rotate the plurality of scintillation fibres about a rotation axis perpendicular to the first direction such that signals can be generated by the plurality of photodetector regions for different orientations about the rotation axis of the plurality of scintillation fibres coupled to the photodetector regions.

In accordance with some embodiments, each of the plurality of photodetector regions is configured to integrate at least one parameter of signals received from one or more of the plurality of parallel scintillation fibres over a predetermined integrating period.

In accordance with some embodiments, the photodetector comprises a photodetector panel comprising an array of sensor pixels, and wherein each of the plurality of photodetector regions comprises one or more sensor pixels.

In accordance with some embodiments, the photodetector comprises a complementary metal oxide semiconductor panel.

In accordance with some embodiments, the photodetector is coupled to the plurality of parallel scintillation fibres such that a plurality of the photodetector regions is coupled to each of the plurality of parallel scintillation fibres.

In accordance with some embodiments, the dosimeter comprises a further plurality of scintillation fibres extending substantially parallel to a second direction in the sensing region and arranged in a two-dimensional array in a plane perpendicular to the second direction; and a plurality of photodetector regions coupled to respective ones of the further plurality of scintillation fibres so as to generate signals for respective ones of the photodetector regions in response to radiation interaction events in corresponding ones of the further plurality of scintillation fibres, and wherein the first direction is different to the second direction.

In accordance with some embodiments, the plurality of vertically stacked planes comprises planes of scintillation fibres oriented in the first direction, interleaved with planes of scintillation fibres oriented in the second direction.

In accordance with some embodiments, the dosimeter comprises a stack of scintillation fibre carriers, wherein each scintillation fibre carrier comprises a plane of scintillation fibres oriented in the first direction.

In accordance with some embodiments, each scintillation fibre carrier further comprises a plane of scintillation fibres oriented in the second direction

In accordance with some embodiments, the first direction is orthogonal to the second direction.

In accordance with some embodiments, the dosimeter comprises a controller configured to determine a spatial distribution of a radiation dose in the sensing region by applying a reconstruction algorithm to data representing signals collected from the plurality of photodetector regions, wherein the data comprise signals collected from the plurality photodetector regions when the plurality of scintillation fibres are oriented in a first orientation, and signals collected from the plurality photodetector regions when the plurality of scintillation fibres are oriented in a second, different orientation.

In accordance with an embodiment of the present disclosure there is provided a method of characterising a spatial distribution of a radiation dose in a sensing region of a dosimeter comprising a plurality of scintillation fibres extending substantially parallel to a first direction in the sensing region and arranged in a two-dimensional array in a plane perpendicular to the first direction; a photodetector comprising a plurality of photodetector regions coupled to respective ones of the plurality of scintillation fibres so as to generate signals for respective ones of the photodetector regions in response to radiation interaction events in corresponding ones of the scintillation fibres; and a controller arranged to receive the signals from the photodetector regions; wherein the method comprises the steps of: receiving, by the controller, signals generated for respective ones of the photodetector regions in response to radiation interaction events in corresponding ones of the scintillation fibres; and determining, by the controller, a spatial distribution of a radiation dose in the sensing region based on the extent to which the signals from the plurality of photodetector indicate there have been radiation interaction events in different ones of the scintillation fibres.

### BRIEF DESCRIPTION OF THE DRAWINGS

Embodiments of the disclosure will now be described, by way of example only, with reference to the accompanying drawings, in which:

FIG. 1 is a schematic diagram of a radiotherapy approach in accordance with some embodiments of the disclosure.

FIG. 2 is a schematic diagram of a sensing region of a dosimeter in accordance with some embodiments of the disclosure.

FIG. 3 is a schematic diagram of a cross-section through a sensing region of a dosimeter in accordance with some embodiments of the disclosure.

FIG. 4 is a schematic diagram of a sensing assembly of a dosimeter in accordance with some embodiments of the disclosure.

FIG. 5 is a schematic diagram of a sensing region of a dosimeter in accordance with some embodiments of the disclosure.

FIG. 6 is a schematic diagram of a sensing region of a dosimeter in accordance with some embodiments of the disclosure.

FIG. 7 is a schematic diagram of a scintillation fibre carrier in accordance with some embodiments of the disclosure.

FIG. 8 is a schematic diagram of an aspect of a reconstruction approach in accordance with some embodiments of the disclosure.

FIG. 9 is a schematic diagram of a rotating dosimeter arrangement in accordance with some embodiments of the disclosure.

FIG. 10 is a schematic diagram of proton radiography technique using a dosimeter arrangement configured according to embodiments of the disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

Aspects of the present disclosure relate to a dosimeter for characterising a spatial distribution of a radiation dose in a sensing region of the dosimeter. The radiation dose to be characterised may be delivered by an apparatus configured to provide an incident beam of ionising radiation, for example, a beam of X-rays, gamma rays, or charged particles such as protons or ions. However, it will be appreciated that the specific type of radiation to be characterised is not of particular significance, and a dosimeter according to the present disclosure may be configured to characterise the spatial distribution of a radiation dose provided by any form of ionising radiation.

The sensing region of the dosimeter comprises a volume of the dosimeter in which a radiation dose may be delivered by an incident beam of radiation. The sensing region will therefore comprise matter which is configured to interact with an incident radiation beam, such that energy from the radiation beam is absorbed by the matter. As described further herein, the sensing region may comprise void spaces occupied by gas (for example, as artifacts of manufacturing process such as resin perfusion) in addition to solid matter such as scintillation fibres, or the sensing region may alternatively be entirely occupied by solid matter. The sensing region comprises a plurality of scintillation fibres, wherein each scintillation fibre comprises scintillation material which is configured to absorb radiation from an incident radiation beam, causing emission of scintillation photons within the scintillation material, at least a fraction of said photons being guided by the scintillation fibre towards one or more photodetector regions of a photodetector. As described further herein, the sensing region comprises a plurality of scintillation fibres which extend at least partially through the sensing region, though it will be appreciated that portions of a given scintillation fibre may extend outside the sensing region (for example, to enable photons emitted within a portion of a given scintillation fibre within the sensing region to be guided to a photodetector region situated outside the sensing region.

Each of the scintillation fibres is coupled to one or more photodetector regions (for example via a suitable optical coupling approach as described further herein), such that scintillation photons arising from radiation interaction events in a region of a given scintillation fibre are guided along said scintillation fibre and received by one or more of the photodetector regions. The photodetector may comprise one or more flat-panel photodetectors (such as one or more complementary metal oxide semiconductor photodetector panels) comprising a plurality of sensor pixels which are sensitive to photons emitted within the scintillation fibres by incident radiation. In such embodiments, a photodetector region may comprise a single detector pixel, or a plurality of sensor pixels forming a sensor pixel region. Each photodetector region is configured to generate an electrical signal in response to receiving one or more scintillation photons from one or more scintillation fibres to which the photodetector region is coupled. The dosimeter comprises a controller configured to receive signals from the photodetector regions of the detector, and to determine a spatial distribution of a radiation dose in the sensing region based on the extent to which the signals from the plurality of photodetector regions indicate there have been radiation interaction events in different ones of the plurality of scintillation fibres. For example, the controller may integrate signals received from the plurality of photodetector regions over a predetermined integrating time, and store in a suitable memory element values representing one or more parameters of said signals (for example, their magnitude, and/or spectral information).

The controller may determine a spatial distribution of a radiation dose within the sensing region via a computational reconstruction approach applied to data representing the extent to which each of the plurality of photodetector regions indicates there have been radiation interaction events in one or more scintillation fibres coupled to the respective photodetector region. As set out further herein, information about the spatial arrangement of each scintillation fibre within the sensing region (for example, its orientation and extent within the sensing region) may be used as an input in the reconstruction of the spatial distribution of the radiation dose. For example, a plurality of scintillation fibres may extend through the sensing region substantially parallel to a first direction, being arranged in a two-dimensional (2D) array in a first plane perpendicular to the first direction. The plurality of scintillation fibres may terminate at a terminal plane, parallel to the first plane, at which photons emitted within the plurality of scintillation fibres are emitted from first ends of respective ones of the plurality scintillation fibres. In some embodiments, a flat-panel photodetector may be coupled to the first ends of the plurality of scintillation fibres, for example by abutment of a detecting surface of the photodetector to the terminal plane. The photodetector in such an example will comprise an array of photodetector elements, such as sensor pixels, which receive scintillation photons from the array of parallel scintillation fibres. As a consequence of the detector being oriented orthogonal to the direction of the scintillation fibres, scintillation photons arriving via a scintillation fibre at a photodetector region centred on a position xy on the plane of the detecting surface can be considered to have been emitted at points in the sensing region which lie approximately on a vector normal to the detecting surface which intersects the detecting surface at position xy. The degree of approximation, as described further herein, depends, among other factors, on the cross-sectional area of the one or more scintillating fibres which are optically coupled to the photodetector element centred on xy.

Where the detecting surface comprises a 2D array of photodetector regions, each coupled to one or more of the parallel scintillation fibres, signals generated by the array of photodetector regions and received by the controller during a predetermined integrating period may be used by the controller to reconstruct a 2D image, whereby each pixel of the 2D image corresponds to a measure of the signal received from a photodetector region during the integrating period (where, for example, the pixel intensity is proportional to the magnitude of the signal received from the respective photodetector region during the integrating period). For example, where the photodetector comprises a 1000×1000 array of photodetector regions, the controller may reconstruct a 1000×1000 pixel image where each pixel has a value proportional to the count of photons arriving on the detecting surface of the photodetector from one or more scintillating fibres coupled to one or more photodetector regions at a corresponding position on the photodetector, integrated over a predetermined integrating period. Accordingly, due to the parallel orientation of the fibres in a direction substantially orthogonal to the detecting surface, such an image comprises a representation of the dose received in the sensing region, integrated along a vector normal to the detecting surface. In use of the dosimeter, one or more beams of radiation may be directed into the sensing region (e.g. as part of a treatment plan), and one or more such 2D images may be reconstructed by the controller, by collecting signals from the plurality of photodetector regions over a predetermined integrating time whilst the one or more beams are causing radiation interaction events within the sensing region. Images may be reconstructed for sets of parallel scintillation fibres oriented substantially parallel to different directions, by providing sets of scintillation fibres extending through the sensing region and oriented substantially parallel to different directions in the sensing region, and/or by rotating the one or more sets of parallel scintillation fibres around an axis of rotation normal to the direction of extent of one of the sets of parallel scintillation fibres within the sensing region, and reconstructing by the controller, for different angles of rotation relative to a datum, images from signals received from the plurality of photodetector regions. A plurality of such images may be input to an algorithm to reconstruct a three-dimensional distribution of estimated photon emission within the sensing region by, for example, the controller applying a filtered back-projection or iterative reconstruction algorithm to the images.

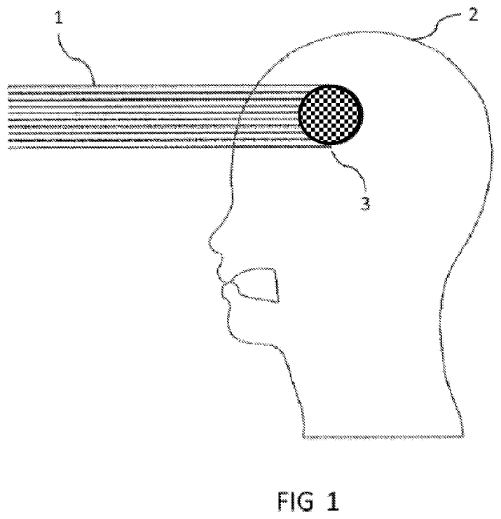

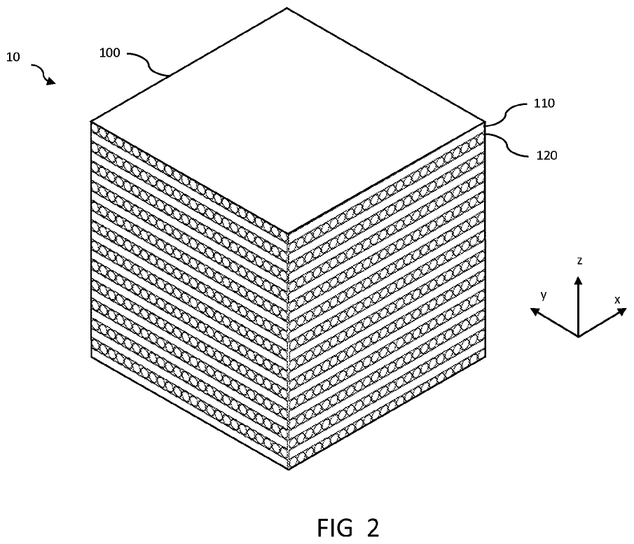

FIG. 2 schematically shows a sensing region 100 of a dosimeter 10 according to embodiments of the present disclosure. In FIG. 2, the sensing region 100 is in the form of a cube, though as described further herein, other sensing region geometries may be adopted, such as a cuboidal, cylindrical, or other geometry. In the arrangement of FIG. 2, the sensing region 100 comprises a plurality of scintillation fibres 110 extending substantially parallel to a first direction in a sensing region of the dosimeter, which corresponds to the x direction according to the exemplary reference system shown schematically in FIG. 1. The term ‘scintillation fibre’ may be considered to describe an elongate photon-guiding element comprising a scintillating material which emits photons when it interacts with incident photons or charged particles. Each of the plurality of scintillation fibres 110 is configured to interact with incident radiation, such that incident photons/particles from an incident beam of radiation may cause scintillation events as a consequence of interaction with the scintillating material of said fibre, leading to emission of photons within the fibre, which are then guided towards an end of the fibre. It will be appreciated that the interaction of photons and charged particles with matter and the emission of scintillation photons are stochastic processes, and that consequently incident photons or charged particles passing through each of the scintillation fibres 110 may or may not cause emission of one or more scintillation photons in a given fibre. Typically, each of the scintillation fibres 110 comprise clad scintillation fibres, in which a scintillating and photon-guiding core is coated with a cladding material which is selected to control the trapping efficiency of each scintillation fibre. It will be appreciated the wavelength of scintillation photons emitted within and guided by each scintillation fibre may or may not be in the visible portion of the spectrum. The core of each scintillating fibre is typically clad with a cladding material of a lower refractive index than that of the core material to promote total internal reflection within the core. In one example, the fibres comprise a polystyrene core, and the cladding material comprises polymethyl methacrylate (PMMA). The scintillation fibres 110 may also comprise multi-clad fibres, comprising two or more layers of cladding around the core, wherein the refractive index of the layers decreases with distance out from the core. The trapping efficiency of each fibre can be controlled by varying the refractive indices of the core and cladding materials and the cross section of the core. The core material will generally comprise a base material (e.g. polystyrene), which may optionally be doped with one or more fluors/luminophors which absorb photons emitted via scintillation of the base, and emit photons with a longer wavelength, which may be more easily guided by the core.

The scintillation properties of the scintillation fibres may be varied by selection of different core and cladding materials known to the skilled person. The core and cladding materials, and one or more fluors/luminophors used as dopants in the core, can be selected based on a particular type of radiation to be characterised by the dosimeter, and a desired transmission and trapping efficiency, based for example on experimentation and/or modelling. Accordingly, the skilled person may select different core and cladding materials depending on whether the dosimeter is to be used primarily for characterising the spatial distribution of a radiation dose from a proton source, an X-ray source, a gamma radiation source, or another source of radiation. It will be appreciated that characteristic wavelengths of scintillation photons emitted within the plurality of scintillation fibres 110 will vary in dependence on characteristics of incident radiation to be characterised by the dosimeter, such as, for example, the accelerating potential and the type of radiation to be used in a treatment plan, and on the material(s) from which the scintillation fibres 110 are constructed. Accordingly, scintillation photons may be in, for example, the ultraviolet, visible, or infra-red regions of the electromagnetic spectrum. St Gobain Crystals and Kuraray are two examples of commercial manufacturers of scintillation fibres which may be used in dosimeters according to the present disclosure.

The sensing region 100 of the dosimeter 10 may be considered to comprise a volumetric region within the dosimeter which is configured to receive a radiation dose from an incident source of radiation, and which comprises scintillation fibres configured to emit scintillation photons in response to the received dose which can be detected by one or more photodetector regions of a photodetector, with the emission of photons within each of a plurality of subregions of the sensing region being proportional to the integral of the radiation dose absorbed in each sub-region (i.e. in the portions of scintillation fibres extending through said subregion). Signals received by one or more photodetector regions coupled to one or more scintillation fibres extending through a given subregion can be transmitted to a controller, and used by the controller to characterise the received radiation dose in said subregion during a predetermined integrating period, according to reconstruction principles set out further herein. Accordingly, the sensing region 100 may be considered to comprise a region of the dosimeter 10 within which the spatial distribution of a radiation dose can be characterised by a controller. The sensing region 100 shown schematically in FIG. 2 comprises a cubic sensing region 100, within which a plurality of scintillation fibres 110 extends substantially parallel to a first direction, which is denoted as the x direction. The term ‘substantially parallel’ indicates that the plurality of scintillation fibres 110 may not all be exactly parallel to the first direction. Accordingly, in some embodiments all the plurality of scintillation fibres 110 extending within the sensing region may be oriented within 5 degrees of the first direction, or within 3 degrees of the first direction, or within 1 degree of the first direction, or within 0.5 degrees of the first direction, or within 0.1 degrees of the first direction, or within 0.01 degrees of the first direction. Each of the plurality of scintillation fibres 110 extends substantially parallel to the first direction (i.e. the x direction) over the portion of said fibre which is within the sensing region. However, portions of the plurality of scintillation fibres outside the sensing region may not be substantially parallel to the direction. For example, portions of the plurality of the scintillation fibres 110 outside of the sensing region 100 (not shown) may be curved in order to guide photons within the scintillation fibres to one or more photodetector regions positioned outside the sensing region 100.

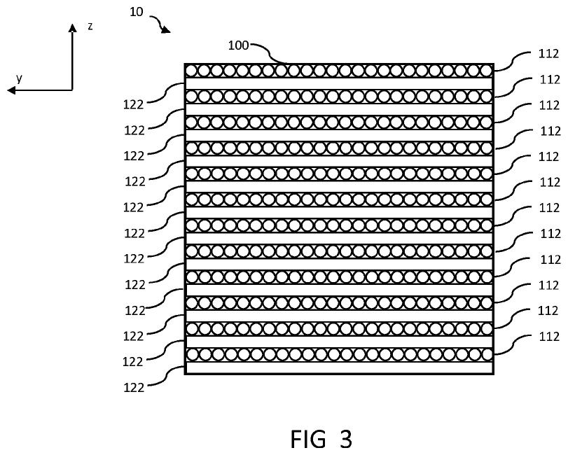

FIG. 3 shows schematically a planar cross-section through the sensing region shown schematically in FIG. 2. In the reference scheme of FIG. 2, FIG. 3 shows a cross section through the sensing region 100 which is aligned with the yz plane. The yz plane is perpendicular to the x direction, and the plurality of scintillation fibres 110 are arranged in a plurality of stacked layers 112 of scintillation fibres, such that the plurality of scintillation fibres 110 are arranged in a two-dimensional array in the yz plane. In the example schematically shown in FIG. 3, the plurality of scintillation fibres 110 are arranged in uniform layers 112 stacked along the z direction, however, this is not essential, and other arrangements are possible as described further herein. Each layer 112 of scintillation fibres may comprise a prefabricated mat or ribbon of individual scintillation fibres which are bonded together such that all the scintillation fibres within a layer 112 are oriented in substantially the same direction (i.e. substantially parallel to it). The layers 112 may be bonded together using, for example, a polymer resin. Layers 112 of scintillation fibres in the form of pre-fabricated mats may be stacked together in a jig which maintains the layered geometry shown schematically in FIGS. 2 and 3, or individual scintillation fibres may be stacked together into layers 112 in a jig which likewise maintains the layered geometry shown in FIGS. 2 and 3. The plurality of scintillation fibres 110 may then be fixed in position within the sensing region 100 by infusing a polymer resin into the sensing region (and potentially regions extending outside it) and curing the resin to bond the scintillation fibres 110 together, and/or by supporting the scintillation fibres 110 in a suitable supporting structure as described further herein, such as a stack of scintillation fibre carriers.

The plurality of scintillation fibres 110 shown schematically in FIGS. 2 and 3 have a circular cross section. However, this is not essential, and alternative cross-sectional geometries may be selected. For instance, scintillation fibres with a square or cuboidal cross section may be used. This may be considered advantageous as scintillation fibres with a square or cuboidal cross-section can be packed more closely within the sensing region 100 than fibres with a circular cross section (in terms of the proportion of the cross-sectional area occupied by fibres in a sectional plane oriented perpendicular to the fibre direction). Increasing the packing density of a plurality of scintillation fibres 110 within the sensing region 100 may improve the efficiency of the dosimeter 10 by increasing the likelihood that a photon or particle from an incident radiation beam will interact with the core of one of the plurality of scintillation fibres 110 to cause emission of one or more scintillation photons. Where the scintillation fibres 110 are not close packed, the interstitial spaces between fibres may be filled by, for example, a resin material, following arrangement of the scintillation fibres using a suitable jig and/or support to align them substantially parallel to a first direction, as described further herein. For instance, a polymer resin in liquid form may be introduced into void spaces not occupied by scintillation fibres, and then cured, embedding the fibres in a solid resin matrix. The radiological properties of the resin may be selected to closely approximate those of human tissues.

The cross-sectional width of the scintillation fibres may be selected in dependence on a number of factors. For example, thinner fibres may be selected to increase the spatial resolution of the dosimeter (as described further herein), or thicker fibres may be selected. In some examples, each one of the plurality scintillation fibres 110 has a width of between 0.5 and 3 mm. The scintillation fibres may alternatively be defined by a characteristic cross-sectional area. For example, the scintillation fibres may have a characteristic cross-sectional area of between 0.2 and 7 mm². However, it will be appreciated that scintillation fibres of any width or cross sectional area could be used.

Each of the plurality of scintillation fibres 110 comprises a first and second end. The first and/or second end of each scintillation fibre may terminate at the boundary of the sensing region 100. For example, in the arrangement of FIG. 2, the yz faces of the cubic sensing region 100 may comprise terminal faces at which each of the plurality of scintillation fibres 110 terminates. In other embodiments, some or all of the scintillation fibres 110 may extend beyond the sensing region 100 (not shown), and the sensing region 100 shown in FIG. 2 may be considered to be a sub-region of a larger volume (e.g. a stack of scintillation fibres), which may have the same shape as the sensing region 100. Accordingly, the external boundaries of a stack of scintillation fibres (for example having a cubic geometry as shown in FIG. 2) may comprise the boundaries of the sensing region 100, and the term ‘stack’ may be considered to be interchangeable with the term ‘sensing region’. In other embodiments, the sensing region may comprise a sub-region (i.e. a sub-volume) within a stack of scintillation fibres such as the cubic stack shown schematically in FIG. 1. For example, a cuboidal stack of scintillation fibres as shown in FIG. 2, with xy, yx, and xz outer faces, may comprise a sensing region 100 comprising a sub-region/sub-volume within the stack having, for example, a cubic, cuboidal, cylindrical, or other geometry.

Each of the scintillation fibres 110 is coupled to one or more photodetector regions of one or more photodetectors as described further herein. Each of the photodetector regions comprises one or more photosensitive sensing elements configured to generate an electrical signal in response to detecting incident photons. In this respect, the photodetector regions may be constructed according to any photon sensing technology known to the skilled person. For example, the photodetector regions may comprise electro-optical sensing elements such as photodiodes, phototransistors, photoresistors, photovoltaic elements, or metal oxide semiconductor elements. In preferred embodiments of the current disclosure, the photodetector regions comprise sub-regions of a photodetector such as a charge-coupled device (CCD) panel or a complementary metal oxide semiconductor (CMOS) panel. What may be considered significant is that each of the photodetector regions of the photodetector is configured to generate an output signal in dependence on a degree to which photons emitted within one or more the plurality of scintillation fibres 110 are received from the one or more scintillation fibres by said photodetector region. The photodetector will be selected such that the photodetector regions have a sensitivity to the range of wavelengths of photons emitted by the scintillation fibres in response to the radiation dose received by the sensing region 100, which may be determined by the skilled person through experimentation and/or modelling.

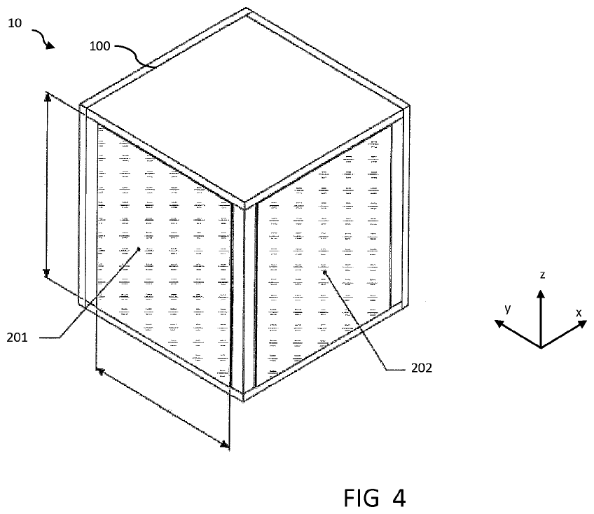

A variety of approaches may be used to couple each of the plurality of scintillation fibres 110 to one or more photodetector regions of one or more photodetectors comprised in the dosimeter 10. In some instances, one or more scintillation fibres from the plurality of scintillation fibres 110 are coupled (e.g. optically coupled) to one or more photodetector regions comprised in a scintillation counter. However, in preferred embodiments, first ends of each of the plurality of scintillation fibres 110 terminate at a flat emission surface (such as one of the yz planar surfaces shown schematically in FIG. 2), against which a flat panel photodetector comprising a plurality of photodetector regions is abutted, optionally with one or more interstitial faceplates and/or filters interposed between the emission surface and the photodetector, as described further herein. One or more air gaps may be provided between one or more of these elements. FIG. 4 will be recognized from FIG. 2, and shows a sensing region 100 comprising a plurality of scintillation fibres (not shown) extending through the sensing region 100 substantially parallel to a first direction, corresponding to the x direction, as in FIG. 2. A photodetector 201 comprising a plurality of photodetector regions (not shown) is abutted against one of the external zy faces of the sensing region 100 to receive photons emitted from respective first ends of each of the plurality of scintillation fibres 110. It will be appreciated that not all of the scintillation fibres in the plurality of scintillation fibres 110 are necessarily coupled to one or more photodetector regions of the photodetector 201 (i.e. the photodetector 201 may not overlap in the yz plane with the first ends of all of the plurality of scintillation fibres 110).

Where the emission surface is flat (e.g. the yz planar surface against which the photodetector 201 is abutted in FIG. 4), it may be machined in order to achieve a desired degree of flatness, and to improve emission of photons from the first ends of ones of the plurality of scintillation fibres 110 which terminate at the flat emission surface. However, in other embodiments, the emission surface at which first ends of the plurality of scintillation fibres 110 terminate may not be flat, and may be for example curved. For instance, the sensing region 100 may comprise a cylindrical sensing region, and a stack comprising a plurality of scintillation fibres 110 may be arranged in the form of a cylinder (which may, for example, be formed by machining a block/stack comprising a plurality of parallel scintillation fibres 110 embedded in a plastics material such as a resin as set out further herein). In one embodiment, a photodetector comprising a flexible array of photodetector regions comprising sensor pixels may be abutted to a curved emission surface on the exterior of the stack of scintillation fibres 110 comprising the cylindrical sensing region 100.

Photodetector 201 may comprise a single flat-panel detector, such as a single CMOS panel, or may comprise a plurality of flat-panel detectors butted along their edges to form a tiled detection surface comprising photodetector regions of a plurality of individual detector units. This approach can be used to enlarge the detection surface of the photodetector 201, and increase the number of photodetector regions (e.g. sensor pixels) available in the photodetector 201. Where the sensing region 100 and/or a stack comprising a sensing region 100 is cuboidal, the x, y and z dimensions of the sensing region 100/stack may be matched to the dimensions of the photodetector 201 (which may be a tiled photodetector). The coupling of the first ends of the plurality of scintillation fibres 110 and the plurality of photodetector regions of the photodetector 201 may follow a one-to-one scheme, whereby each scintillation fibre (e.g. the first end of said fibre) is optically coupled to a single photodetector region (for example, a single sensor pixel). In other embodiments, a plurality of photodetector regions (for example a plurality of sensor pixels) are optically coupled to a given scintillation fibre (e.g. to the first end of said fibre). This may be considered advantageous because collecting photons from a single scintillation fibre using a plurality of photodetector regions (e.g. sensor pixels) or a single photodetector region comprising a plurality of sensor pixels, can increase the accuracy and/or sensitivity of detection of photons by the dosimeter 10 (e.g. the signal to noise ratio). For example, in one embodiment, the photodetector 201 comprises a CMOS imaging panel with an array of 2400×4800 photodetector regions comprising photosensitive pixels disposed on a detecting surface of the photodetector 201, each having a sensing area of 50×50 um. For the sake of providing a concrete example, when a scintillation fibre with a square cross-section of 1 mm by 1 mm is coupled to the photodetector (for example by abutting the first end of said scintillation fibre against the detecting surface of the photodetector 201 along a vector normal to the detecting surface, the end face of the first end of the scintillation fibre will overlap an array of 20×20 photodetector regions in the plane of the detection surface, such that a scintillation photon emitted from the first end of the scintillation fibre may be detected by one or more of the photodetector regions overlapping the first end of the scintillation fibre. The controller 600 may average or preferably sum the signal output by a plurality of photodetector regions coupled to each respective one of a plurality of scintillation fibres over a predetermined integrating period (for example, 33 milliseconds) to determine a value representative of the dose of radiation absorbed by the scintillation fibre during the integrating period. In other embodiments, a plurality of scintillation fibres comprising a subset of the plurality of scintillation fibres may be coupled to a single one of the photodetector regions. It will be appreciated the photodetector region dimensions provided herein are exemplary, and other values may be selected by the skilled person. For example, sensor pixels comprising photodetector regions of the photodetector may have a square, circular or other cross-section, and may have a width of, for example, less than 200 um, less than 100 um, less than 75 um, less than 50 um, less than 25 um, less than 10 um, less than 5 um, or less than 1 um. The ratio of the scintillation fibre diameter and the photodetector region size may be selected by the skilled person based on experimentation and/or modelling.

As set out further herein, in some embodiments, a fibre optic faceplate (not shown) is disposed between the first ends of the plurality of scintillation fibres 110 and the plurality of photodetector regions comprised in the photodetector (e.g. photodetector 201 shown schematically in FIG. 4) in order to couple (e.g. optically couple) the first ends of the plurality of scintillation fibres 110 to the photodetector regions. In some embodiments, one or more filters may be comprised within the fibre optic faceplate, and/or disposed between the first ends of the plurality of scintillation fibres 110 and the photodetector regions in addition to or in place of the fibre optic faceplate. In some embodiments, the one or more filters comprise a neutral density filter. The filter characteristics may be selected to attenuate signals (e.g. the optical signal) emitted from the plurality of scintillation fibres 110 to ensure that the capacity of the photodetector regions is not exceeded (e.g. oversaturated) during the integrating time used by the controller to measure the signal generated for each of the photodetector regions whilst radiation is being directed into the sensing region 100 causing emission of scintillation photons in the scintillating fibres 110 (for example, so that the charge storage capacity of photodetector regions comprising sensor pixels of a CMOS photodetector is not exceeded).

In some embodiments, the plurality of scintillation fibres 110 may be provided with reflecting means at a second end of each of the scintillation fibres distal to the first end which is coupled to one or more photodetector regions. Where provided, one or more reflecting means are configured to reflect light/photons reaching the second end of each of the scintillation fibres back into the respective scintillation fibre core and towards the first end. This may increase the detection efficiency for photons emitted within a given scintillation fibre by reducing or eliminating photon losses from the second end of said fibre, and increasing the likelihood photons guided to the second and are guided back to the first end and received by the photodetector. In some embodiments, each of the plurality of scintillation fibres 110 is provided with an individual reflector, which may be a retroreflector element. In other embodiments, a single reflecting element may be coupled (e.g. optically coupled) to second ends of each of a plurality of scintillation fibres 110. Where second ends of each of the plurality of scintillation fibres 110 terminate at a planar surface (for example one of the yz faces shown in FIG. 2), a planar reflector may be mated to said planar surface in a similar manner to that used to couple photodetector 201 to the plurality of scintillation fibres 110, and the planar surface may be machined as set out further herein. In other embodiments, the second ends of each of the plurality of scintillating fibres 110 may be coupled to a plurality of photodetector regions of a further photodetector (for example comprised in a second photodetector panel (not shown) arranged on a planar outer surface of the sensing region/stack of scintillation fibres 100 shown schematically in FIG. 2, being aligned with a zy face of the sensing region 100/stack of scintillation fibres opposite to that at which photodetector 201 is disposed.

In accordance with embodiments of the present disclosure, and as shown schematically in FIG. 2, a further plurality of scintillation fibres 120 may be provided extending substantially parallel to a second direction in the sensing region 100 of the dosimeter 10, and arranged in a two-dimensional array in a plane perpendicular to the second direction, with a further plurality of photodetector regions coupled to respective ones of the further plurality of scintillation fibres 120 so as to generate signals for respective ones of the photodetector regions in response to radiation interaction events in corresponding ones of the further plurality of scintillation fibres 120. FIG. 2 shows a further plurality of scintillation fibres 120 which are aligned substantially parallel to a second direction, which corresponds to the y direction in the reference system of FIG. 2. The term ‘substantially parallel’ will be considered to have the same meaning as used in respect of the plurality of scintillation fibres 110. In FIG. 2, the further plurality of scintillation fibres 120 are oriented substantially parallel to a direction which is substantially orthogonal to the first direction (i.e. the direction to which the plurality of scintillation fibres 110 are oriented substantially parallel). The term substantially orthogonal will be taken as meaning that the first and second directions may not be aligned at exactly 90 degrees to one another, but may be, for example, between 75 and 95 degrees, between 76 and 94 degrees, between 77 and 93 degrees, between 78 and 92 degrees, or between 89 and 91 degrees to one another. As set out further herein, in other embodiments, the first and second directions may not be substantially orthogonal, but may be oriented at, for example, substantially 45 degrees to each other. The combination of a stack/sensing region 100 and one or more photodetector regions may be termed a sensing assembly.

FIG. 3 shows a planar cross-section through the sensing region 100 shown schematically in FIG. 2. In the reference scheme of FIG. 2, FIG. 3 shows a cross section through the sensing region 100, and aligned with the yz plane. The yz plane is perpendicular to the x direction, and the further plurality of scintillation fibres 120 are arranged in stacked layers 122 of scintillation fibres, such that the plurality of scintillation fibres 120 are arranged in a two-dimensional array in the xz plane. Accordingly, in FIG. 3, a cross-section of a single scintillation fibre of each layer 122 is shown, with the long axis of each scintillation fibre lying in a yz plane, and extending in the y direction. In the example schematically shown in FIGS. 2 and 3, the plurality of scintillation fibres 120 are arranged in uniform layers 122, however, this is not essential, and other arrangements are possible as described further herein. As shown schematically in FIGS. 2 and 3, layers 112 of scintillation fibres oriented substantially parallel to the first direction (e.g. x) are stacked in alternating arrangement with layers 122 of scintillation fibres oriented substantially parallel to the second direction (e.g. y), being stacked in the z direction. However, in other embodiments, different stacking arrangements may be adopted. For example, sets of two, three, four, five or more layers 112 of scintillation fibres extending substantially parallel to the first direction may alternate with sets of two, three, four, five or more layers 122 of scintillation fibres extending substantially parallel to the second direction). Furthermore, layers 112 and 122 of scintillation fibres may not uniform (in the sense of all scintillation fibres in each layer being substantially centred on the same plane) but may be staggered in the out-of-plane direction, whilst being substantially parallel to the plane (e.g. the yz plane in the reference scheme of FIGS. 2 and 3).

Where a further plurality of scintillation fibres 120 is provided extending through the sensing region 100, a further photodetector 202 can be coupled to the further plurality of scintillation fibres 120 in the same manner as described for the coupling of the photodetector 201 to the plurality of scintillation fibres 110. FIG. 4 schematically shows a further photodetector 202 aligned parallel to the zx plane, abutted to an emission surface of the scintillation fibre stack/sensing region 100 at which first ends of the further plurality of scintillation fibres 120 terminate. This may broadly follow the approaches described herein for coupling a first photodetector 201 to a plurality of scintillation fibres 110. Alternatively, the plurality of scintillation fibres 120 may extend beyond the sensing region boundary, being curved round to couple with photodetector regions comprised in the photodetector coupled to the plurality of scintillation fibres 110, such that a single photodetector can be used to collect photons from the plurality of scintillation fibres 110 and the plurality of scintillation fibres 120. Scintillation fibres 110 may also extend beyond the sensing region 100 and may be curved such that ends of scintillation fibres 110 and 120 can be coupled to a photodetector which is not mated to a face of the sensing region 100 or a stack comprising the sensing region 100.

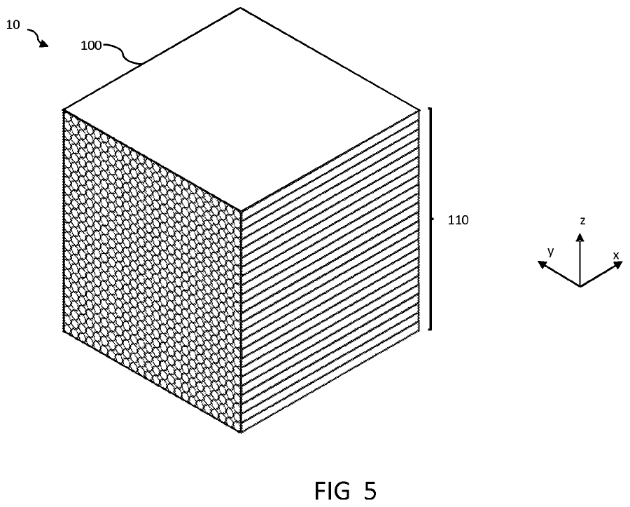

It will be appreciated that whereas FIGS. 2 to 4 show sensing regions in which two sets of scintillation fibres are provided, the two sets respectively comprising a first plurality of scintillation fibres 110 extending through the sensing region substantially parallel to a first direction, and a further plurality of scintillation fibres 120 extending through the sensing region substantially parallel to a second direction, with first and second directions being substantially orthogonal, other configurations are possible. For example, a dosimeter 10 may be provided with a sensing region in which all the scintillation fibres extending through the sensing region are oriented substantially parallel to a single direction. FIG. 5 shows schematically a sensing region 100, which will be recognized from FIG. 2, except that all the scintillation fibres 110 extending through the sensing region are substantially parallel to a single direction (i.e. the x direction in the reference scheme of FIG. 5), and a further plurality of scintillation fibres 120 is not provided. In other respects, the coupling of a plurality of photodetector regions of a photodetector to the plurality of scintillation fibres 110 may be carried out according to approaches described further herein.

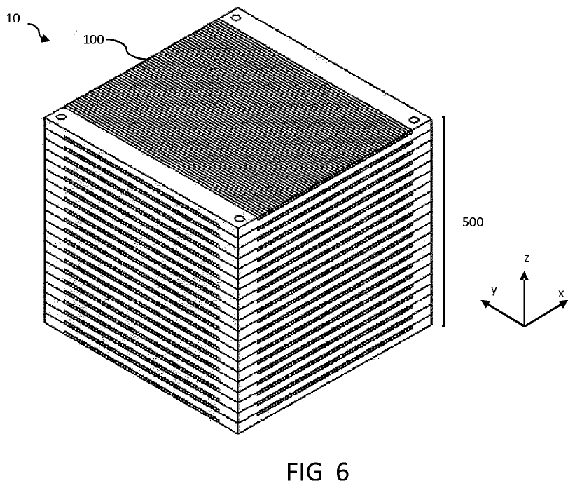

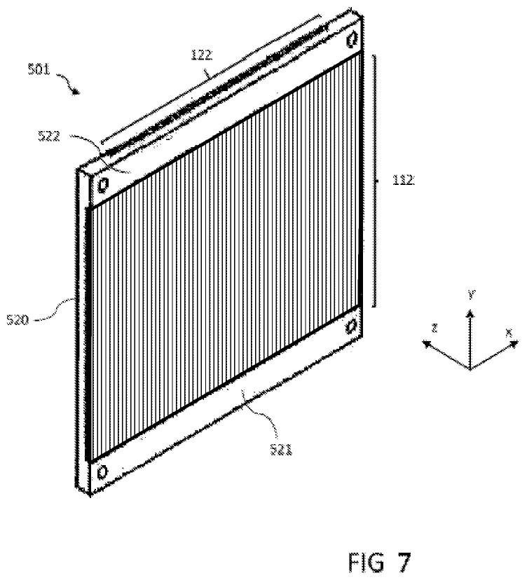

In some embodiments, the construction of a stack of scintillation fibres to define a sensing region 100 through which scintillation fibres extend may follow an approach in which a plurality of scintillation fibre carriers 500 are arranged to form the sensing region 100. FIG. 6 will be recognized from FIG. 2, and shows a stack/sensing region 100 constructed according to an approach in accordance with the present disclosure, in which layers of scintillation fibres 112 and 122 comprising respectively layers 112 of a plurality of scintillation fibres 110 extending through the sensing region 100 substantially parallel to a first direction, and layers 122 of a further plurality 120 of scintillation fibres extending through the sensing region 100 substantially parallel to a second direction which is substantially orthogonal to the first direction, are supported by a plurality of scintillation fibre carriers 500. Each one of the scintillation fibre carriers 500 comprises a support element 510 which supports at least a first layer of scintillation fibres 112 oriented substantially parallel to a first direction in a region of the scintillation fibre carrier which is to be within the sensing region 100 when the scintillation fibre carriers 500 are stacked together. The sensing region 100 may comprise substantially all of the stack of scintillation fibre carriers 500, or may comprise a sub-volume defined within the stack of scintillation fibre carriers 500. Optionally, at least one further layer of scintillation fibres 122 is arranged in or on each substantially planar support element 520 such that the scintillation fibres 122 extend substantially parallel to a second direction on the support element 520. FIG. 7 shows schematically a scintillation fibre carrier 501 in accordance with an embodiment of the present disclosure. The scintillation fibre carrier comprises a support element 510, which in the example of FIG. 7 is a substantially planar, rectangular element having two major sides (i.e. parallel to the xy plane) and four minor sides. The support element will generally be made of a plastics material, though other materials may be used. In the scintillation fibre carrier 501 shown in FIG. 7, each of the two major faces of the support element is recessed to form a channel or slot into which a plurality of scintillation fibres 112 (and/or 122) can be received. For example, a channel may be formed by machining a major surface of the support element 520 (e.g. the support element 520 may be machined from planar stock material), or the support element 520 may be directly formed with a channel on each of the major faces. For instance, the support element 520 may be injection moulded or 3D printed from a plastics material with a channel defined on one or both faces. Each channel has a depth relative to non-recessed side-regions 521 and 522 of each major face of the support element, which will in general be equal to the cross-sectional width of the scintillation fibres 112 to be supported by the support element. Where a channel is defined on only one major face of the support element 520, the maximum thickness of the support element 520 (e.g. of the side regions 521, 522) may generally be only slightly thicker than the cross-sectional width of the scintillation fibres 112 to be received in the channel, with the minimum thickness being determined by the skilled person based on the mechanical properties of the material used for the support element (e.g. the rigidity), and the method of manufacture. Where a channel is defined on each of the major faces of the support element 520, the thickness of the support element (inclusive of the depth of the channels) may generally be only slightly thicker than double the width of the scintillation fibres, with the minimum thickness being determined as before. As shown in FIG. 7, each channel has two open sides, orthogonal to the sides bounded by the non-recessed side regions 521, 522 of the support element. A layer of scintillation fibres 112 is received into a first channel, each of the scintillation fibres being oriented substantially parallel to the long edges of the non-recessed side regions 521, 522 defining the channel boundary. The layer of scintillation fibres 112 may comprise a pre-fabricated mat of scintillation fibres, as described further herein, or a plurality of individual scintillation fibres arranged into a layer 112 and held in place during manufacture using, for example, a suitable jig. The scintillation fibres will in general be bonded to the support element 520 using a plastics resin as described further herein. In the example shown in FIG. 7, both major surfaces of the support element comprise a channel in which are received a plurality of scintillation fibres. Where two channels are provided, these are typically oriented orthogonally to one another such that the plurality of scintillation fibres 112 in the first channel extend substantially parallel to a first direction, and the plurality of scintillation fibres 122 in the second channel extend substantially parallel to a second direction, wherein the first and second directions are orthogonal to one another. In any embodiment where scintillation fibres are carried on a scintillation fibre carrier comprising a support element, each scintillation fibre carrier may have the major surface machined following attachment of the scintillation fibres in order to ensure uniform thickness of each scintillation fibre carrier and flatness of the major surfaces.

In other embodiments, the plurality of scintillation fibres may not be received into one or more channels or slots on the support element, but may be directly bonded to a major surface of the support element, or embedded into the support element during manufacture. For example, one or more layers of parallel scintillation fibres may be arranged in a jig, and a support element may be moulded around the scintillation fibres to embed them within the support element. In this embodiment, the support element may be formed from a liquid polymer resin which solidifies on curing. Alternatively, both channels may be defined on one face of the support element 520, being different depths, such that a first layer 112 of scintillation fibres received in the first channel overlies a second layer 122 of scintillation fibres received in the second channel.

The sensing region 100 of the dosimeter may be formed by arranging a plurality of scintillation fibre carriers 500 into a stack, whereby the external boundaries of the stack define the extent of the sensing region 100, or wherein the sensing region 100 comprises a sub-volume within the stack. The individual scintillation fibre carriers 501 may be adhesively bonded or mechanically fixed together at their major surfaces to form the stack. For example, each of the scintillation fibre carriers 500 may comprise a plurality of through-holes (for example, one in each corner of the support element 510, as shown in FIG. 7), and a plurality of scintillation fibre carriers 500 may be arranged into a stack by aligning respective holes on each scintillation fibre carrier, inserting a tie rod through each set of holes, and threading fixings onto opposing ends of the tie rods to compress the stack of scintillation fibre carriers. The tie-rods may comprise a plastics material which may be selected so as to have radiation absorption properties similar to those of the plurality of scintillation fibres 110 and/or the support elements comprised in the stack of scintillation fibre carriers. The material from which the support elements 520 are formed may be selected to have similar radiological properties to the scintillation fibres, in terms of radiation absorption and/or scattering, and may comprise, for example, polystyrene, or may be selected to minimize absorption of radiation by the support elements 520.

In the embodiment shown schematically in FIG. 7, each scintillation fibre carrier 501 comprises two orthogonal layers of scintillation fibres 112 and 122. Accordingly, each of the plurality of scintillation fibre carriers 500 comprised in the stack can be oriented in the same rotational direction around the z axis shown in FIGS. 6 and 7, forming a stack of interleaved layers of scintillation fibres, wherein adjacent layers of scintillation fibres have orthogonal fibre orientations (as shown in FIG. 7). However, it will be appreciated that in other embodiments each scintillation fibre carrier may comprise only a single layer of scintillation fibres 112 (for example, received in a single channel on one side of the respective support element 520). A plurality of such scintillation fibre carriers 500 may be arranged in the same rotational orientation, forming a stack in which all of the plurality of scintillation fibres in the stack are oriented substantially parallel to a first direction in a sensing region within the stack (forming an arrangement similar to that shown schematically in FIG. 5). Alternatively, a plurality of such scintillation fibre carriers may be arranged such that alternating scintillation fibre carriers are oriented at a 90 degree offset to each other around the z axis, forming a stack of interleaved layers of scintillation fibres, wherein adjacent layers have orthogonal scintillation fibre orientations. In some embodiments, a plurality of adjacent scintillation fibre carriers 500 within a stack may be oriented in the same rotational orientation relative to a rotation axis normal to a major face of each support element 520 (e.g. axis z) such that, for example, a plurality of sets of scintillation fibre carriers may be interleaved, where each set of scintillation fibre carriers comprises a plurality of adjacent scintillation fibre carriers oriented in the same direction (for example, more than 1, more than 2, more than 5, or more than 10 scintillation fibre carriers) but where adjacent sets are oriented at different rotational orientations to one another (for example, at 90 degrees rotation in the z axis).

In embodiments whereby the sensing region 100 comprises a plurality of scintillation fibre carriers 500 arranged in a stack, the coupling of a plurality of photodetector elements to the scintillation fibres in the stack may follow the approaches set out further herein. For example, where the sensing region 100 comprises first and second sets of scintillation fibres 110 and 120 respectively oriented substantially parallel to orthogonal orientations, first and second photodetectors 201 and 202 may be coupled to first and second emission surfaces of the stack/sensing region 100 at which first ends of each of the respective first and second sets of scintillation fibres 110 and 120 terminate, in the manner shown schematically in FIG. 4. One or more external faces of the stack/sensing region 100 may be machined as described further herein.

As set out further herein, the dosimeter 10 may comprise a controller, and or is configured to be connected to a controller via suitable digital or analogue connectors. The controller may comprise a general purpose computer configured to run software implementing one or more routines for the collection and processing of signals received from the plurality of photodetector regions and may further run software implementing one of more routines for reconstructing a representation of a spatial distribution of a radiation dose received by the sensing region 100 of the dosimeter 10. It will be appreciated that the collection of signals from a plurality of photodetector regions comprised in one or more photodetectors of the dosimeter 10, the processing of these signals into data (e.g. one or more images or arrays), and the reconstruction of a spatial distribution of a radiation dose from said data may comprise processing steps carried out by separate controllers/computers, with information resulting from each of these steps being transmitted via a suitable data transmission protocol (for example over a local area network) for further steps to be carried out by one or more further controllers/computers. A controller comprised in the dosimeter 10 may in some embodiments only carry out the function of receiving signals from the plurality of photodetector regions, and the reconstruction of a representation of a spatial distribution of a radiation dose received by the sensing region 100 of the dosimeter 10 may be carried out by a further controller which may be physically separate from the dosimeter.

Reconstruction of the spatial distribution of a radiation dose received by the sensing region 100 of the dosimeter 10 on the basis of information about signals received from a plurality of photodetector regions comprised in one or more photodetectors of the dosimeter may be carried out in a variety of different ways, as described further herein. In some embodiments, the controller is configured to collect signals from a first plurality of photodetector regions coupled to a set of scintillation fibres 110 extending through a sensing region 100 of the dosimeter substantially parallel to a first direction, and from a second set of photodetector regions coupled to a further set of scintillation fibres extending through a sensing region 100 of the dosimeter substantially parallel to a second direction which is different to the first direction (and optionally from n further sets of photodetector regions coupled respectively to n further sets of scintillation fibres, each of which n further sets of scintillation fibres comprises a plurality of scintillation fibres extending substantially parallel to one of n further directions through the sensing region 100, each of which is different to the first and second directions). However, in other embodiments, the controller is configured to collect a first set of signals from a plurality of photodetector regions coupled to a set of scintillation fibres extending through a sensing region 100 of the dosimeter substantially parallel to a first direction, and to collect a further set of signals from the same plurality of photodetector regions coupled to the same plurality of scintillation fibres following rotation of the sensing region 100 (for example, around the z axis as shown in FIGS. 2, 4 and 6) such that the plurality of scintillation fibres are extending in a different orientation to the first direction. In general, the rotation of the plurality of scintillation fibres between collection of the first and second sets of signal will comprise a rotation about an axis oriented substantially orthogonal to the direction to which the plurality of scintillation fibres are oriented substantially parallel (e.g. the z axis in the reference schemes of FIGS. 2, 4, 5 and 6). It will thus be appreciated that what may be considered significant is that the dosimeter 10 is configured to allow signals to be collected from photodetector elements coupled to one or more pluralities of scintillation fibres extending along directions substantially parallel to a plurality of different respective orientations, and that this may be achieved either by providing a separate plurality of scintillation fibres oriented substantially parallel to each orientation, such that there are n sets of scintillation fibres for each of n directions in the sensing region, and/or achieved by rotating one or more sets of substantially parallel scintillation fibres through a plurality of rotational steps, and collecting signals, at each rotational step, from a plurality of photodetector regions coupled to the scintillation fibres of each set. Rotating the one or more sets of substantially parallel scintillation fibres between acquisition of signals from the photodetector regions allows signals to be collected by the controller for a larger number of scintillation fibre directions than are physically defined within the sensing region 100. For example, a sensing region 100 of a dosimeter with a first plurality 110 of scintillation fibres oriented substantially parallel to a first direction (such as shown schematically in FIG. 5) can be rotated through 90 degrees (i.e. around the z axis) between acquisition by a controller of a first and second set of signals from a plurality of photodetector regions coupled to the scintillation fibres 110 comprised in the set. This may be considered to have the effect of allowing signals to be collected by photodetector regions of a photodetector couples to sets of scintillation fibres respectively oriented substantially parallel to different directions through the sensing region, without having to physically provide a different set of scintillation fibres for each direction. When compared to a static configuration (where the sensing region is not rotated), introducing rotation between or during collection of signals by the photodetector regions allows data to be collected for n fibre directions using <n distinct sets of scintillation fibres, where each set comprises a plurality of scintillation fibres oriented substantially parallel to a single direction. Similarly, where the sensing region 100 comprises two or more sets of scintillation fibres (such as embodiments with two sets of scintillation fibres as shown schematically in FIGS. 2, 4 and 6), where each set comprises a plurality of scintillation fibres extending substantially parallel to a different direction in the sensing region 100, the sensing region 100 may be rotated through n rotational steps (e.g. around the z axis), with signals being received by a controller from a plurality of photodetector regions coupled to the scintillation fibres of each set (e.g. from respective photodetector regions of each of photodetectors 201 and 202 shown schematically in FIG. 4), between every rotational step.

Where signals are collected from photodetector regions coupled to a plurality of scintillation fibres oriented substantially parallel to a first direction in a sensing region 100, and signals are collected from photodetector regions coupled to a plurality of scintillation fibres oriented substantially parallel to a second direction in the sensing region 100, which is substantially orthogonal to the first direction (whether the dosimeter comprises fibres oriented in different directions in the sensing region, and/or is rotated 90 degrees between collection of signals from the photodetector regions by the controller), the following approach may be used to reconstruct a representation of the three dimensional distribution of the received dose in the sensing region 100 (for example using controller or another controller configured to receive data from controller) based on the received signals.

The reconstruction by a controller of a representation of a spatial distribution of a radiation dose in the sensing region 100 of a dosimeter according to the present disclosure may comprise a dose map which may be described according to a coordinate system such as the x, y, z coordinate system indicated in FIG. 2 (though it will be appreciated that the directions of x, y and z are illustrative, such that, for instance, the z direction does not necessarily correspond to a vertical direction in the dosimeter 10). The dose map may comprise a 3D matrix values, where the value at a given position x1′, y1′, z1′ in the matrix is representative of an estimated radiation dose received at a corresponding positon x1, y1, z1 in the sensing region 100 of the dosimeter. The dose map may be represented as a volumetric image, where a voxel centred on a position x1′, y1′, z1′ in the 3D image/volume is representative of an estimated radiation dose received at a corresponding positon x1, y1, z1 in the sensing region 100 of the dosimeter. It will be appreciated that a scaling factor may be applied between the dimensional scale of the coordinate system in the sensing region, and the dimensional scale of reconstructed dose map in the form of a matrix or 3D image.

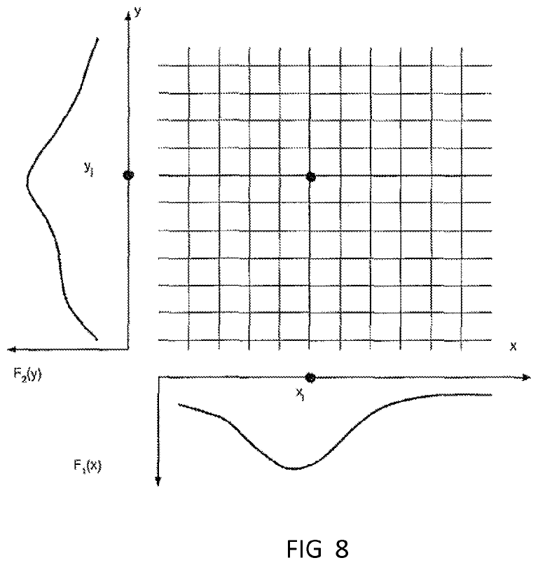

FIG. 8 shows schematically a representation of an xy plane through a sensing region 100, such as that shown in FIG. 2. A 2D dose of radiation in the xy plane through the sensing region at a given depth z, received over an integrating time t, can be described by the function,

f(x, y)=f₁(x)f₂(y)

Where f(x, y) gives the dose at any location in the xy plane. With reference to FIG. 8, the sum of the signal(s) generated during an integrating time t at one or more photodetector regions centred on position xᵢ based on photons arriving at the photodetector region from one or more scintillation fibres oriented substantially parallel to the y direction and coupled to said photodetector region(s), is proportional to the dose received by said scintillation fibre(s), and can be represented by F₁(xᵢ):

F₁(xᵢ)=f₁(xᵢ)Σ_{b}f₂(y_{b})

The same principle holds true in the case of the orthogonal direction, where the sum of the signal for one or more photodetector regions centred on yⱼ can be represented by F₂ (yⱼ):

F₂(yⱼ)=f₂(yⱼ)Σₐf₁(xₐ)

It will be appreciated that xᵢ and yᵢ may also be taken to describe the coordinates of the first ends of scintillation fibres respectively oriented substantially parallel to the y and x directions. Values of f₁(xᵢ) and f₂(yⱼ) can then respectively be expressed by the following functions,

$${f}_{1} ( {x}_{i} ) = \frac{{F}_{1} ( {x}_{i} )}{{\sum }_{b} {f}_{2} ( {y}_{b} )}$$

$${f}_{2} ( {y}_{j} ) = \frac{{F}_{2} ( {y}_{j} )}{{\sum }_{a} {f}_{1} ( {x}_{a} )}$$

The product of these functions gives the reconstructed dose at a point xᵢ, yⱼ in the sensing region 100,

$$f ( {x}_{i} , {y}_{j} ) = {f}_{1} ( {x}_{i} ) {f}_{2} ( {y}_{j} ) = \frac{{F}_{1} ( {x}_{i} )}{{\sum }_{b} {f}_{2} ( {y}_{b} )} \frac{{F}_{2} ( {y}_{j} )}{{\sum }_{a} {f}_{1} ( {x}_{a} )}$$

The denominator in the last equation is the total dose measured at the given depth z in the sensing region 100, and it can be expressed as either Σ_{b}f₂(y_{b}) or Σₐf₁(xₐ), giving the expression for the reconstructed dose at a point xᵢ, yⱼ in the sensing region 100 as,

$$f ( {x}_{i} , {y}_{j} ) = {f}_{1} ( {x}_{i} ) {f}_{2} ( {y}_{j} ) = \frac{{F}_{1} ( {x}_{i} ) {F}_{2} ( {y}_{j} )}{{\sum }_{b} {f}_{2} ( {y}_{b} )}$$

Reconstructing f(xᵢ, yⱼ) for all depths z in the sensing region provides a 3D reconstruction of the spatial dose distribution received in the sensing region 100 during the integrating period t (i.e. the dose map for the radiation dose received during the period t).

Reconstruction of one or more dose maps according to this scheme may be carried out by a controller comprised in the dosimeter, or a controller comprised in a separate apparatus (for example, a general purpose computer comprising a plurality of CPU and/or GPU elements, or a supercomputer cluster) configured to carry out the above computations, according to any suitable approach known to the skilled person (for example, by encoding the instructions in a suitable general purpose programming language such as C, C++, Python, IDL or Matlab.

It will also be appreciated that other computational reconstruction approaches known to the skilled person may be applied to reconstruct a dose map from n sets of signals, where each set of signals comprises signals received from a plurality of photodetector regions coupled to a plurality of scintillation fibres extending through the sensing region along a direction substantially parallel to one of n different directions through the sensing region. In general, the n sets of signals will be obtained for scintillation fibres oriented substantially parallel to n directions constrained to the same plane (for example the xy plane shown in FIG. 2) and intersecting at the same intersection point, wherein the angle between successive ones of the n directions is generally set as 360/2n degrees (though the directions may be selected according to any suitable scheme, and it is not necessary that they are at uniform rotational offsets). The number of directions may be determined by the skilled person, with a larger number of unique directions typically being used to increase the spatial resolution of the dose map reconstructed from the collected signals. A set of signals is collected during an integrating time t by the controller from a plurality of photodetector regions coupled to a plurality of scintillation fibres extending through the sensing region 100 along a direction substantially parallel to a first of the n directions, with this being repeated for each of the n directions to obtain a set of photodetector region signals for each of the n directions (noting that the collection of signals from all photodetector regions of the dosimeter may be substantially simultaneous). As set out further herein, this may be achieved by providing a dosimeter with a sensing region 100 comprising n sets of scintillation fibres, wherein each set comprises a plurality of scintillation fibres extending through the sensing region 100 along a direction substantially parallel to a different one of the n directions, and/or a dosimeter having fewer than n sets of scintillation fibres may be provided, with the sensing region 100 being rotated through a number of rotation steps around an axis of rotation orthogonal to the n directions, with signals collected from the photodetector elements between each rotation step. Where the photodetector regions coupled to scintillation fibres extending through the sensing region 100 and oriented substantially parallel to a given one of the n directions are arranged in an array oriented orthogonal to the given direction, it will be appreciated that a 2D array of values (i.e. an image) representing the intensity of signals received from each photodetector region during a certain integrating time t is analogous to a radiograph known from the field of computed tomography (in that the signal generated at each photodetector region is proportional to the integral of the dose received along one or more scintillation fibres coupled to the photodetector region and oriented substantially orthogonal to the array of photodetector regions). Accordingly, a known 3D reconstruction scheme such as filtered back-projection (using the radon transform) or iterative reconstruction, known to the person skilled in the art, can be applied to a set of such 2D arrays of values, each representing signals received by a plurality of photodetector regions for a different one of n scintillation fibre orientations, in order to reconstruct a 3D dose map of the radiation dose received in the sensing region 100.

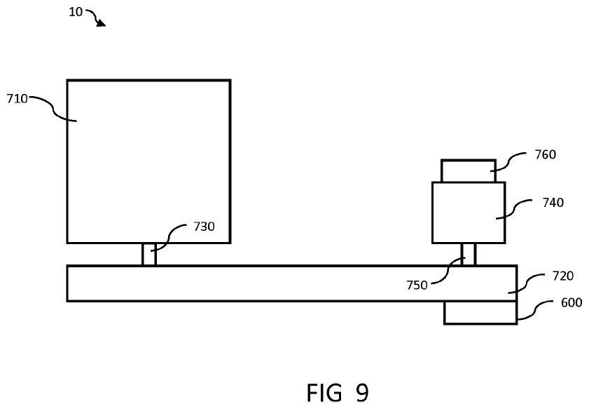

In some embodiments, the dosimeter 10 comprises a rotating dosimeter, in which the sensing region 100 can be rotated in order to allow a controller 600 to collect signals from a plurality of photodetector regions which are coupled to a plurality of scintillation fibres extending through the sensing region substantially parallel to a first direction, wherein sets of signals can be collected for respective different orientations of the first direction relative to a frame of reference outside the dosimeter 10. The general principle of rotating a sensing region 100 between acquisition of sets of signals from a plurality of photodetector regions coupled to scintillation fibres extending through the sensing region 100 is described further herein. FIG. 9 shows schematically an embodiment of a rotating dosimeter 10, in which a stack of scintillation fibres comprising a sensing assembly 710 is rotationally mounted on a support element 720. The sensing assembly 710 typically comprises an arrangement of scintillation fibres comprising a sensing region 100, as described further herein, and examples of which are shown schematically in FIGS. 2, 4, 5 and 6). The sensing assembly 710 typically also comprises one or more photodetectors each comprising a plurality of photodetector regions coupled to the plurality of scintillation fibres comprised in the sensing assembly 710 (such as photodetectors 201 and 202 shown schematically in FIG. 4). The sensing assembly 710 comprises a sensing region 100, a first plurality of scintillation fibres extending through the sensing region 100 substantially parallel to a first direction, and may optionally comprise one or more further pluralities of scintillation fibres extending through the sensing region 100 substantially parallel to each of one or more respective further directions which are different to the first direction, as described further herein. The sensing assembly 710 is mounted on a rotating element 730 which is mechanically coupled to a rotational actuator 740 such as a stepper motor (though any suitable motor or rotational actuator could be used). In the example shown in FIG. 9, a shaft 730 is coupled to the sensing assembly 710, the shaft 730 being mounted to a support element/baseplate 720 via a bearing (not shown). The shaft 730 supports the sensing assembly 710 and constrains it to a rotational degree of freedom around the axis of the shaft 730. The shaft is connected via suitable gearing or pulley arrangement to an output shaft 750 of rotational actuator 740, such that rotational drive from the rotational actuator 740 causes rotation of the sensing assembly 710. Such an arrangement can be configured to gear down the drive from the rotational actuator 740 to the shaft 730. A rotational encoder 760 (such as a shaft encoder) is preferably coupled to output shaft 750, or on another rotating element in the drive system (e.g. a gear train) between the motor and the sensing assembly 710 in order to provide information on the rotational position of the sensing assembly 710. A controller, such as a controller 600, is coupled to the rotational actuator 740 and to the rotational encoder 760 by suitable digital or analogue interfaces, and is configured to drive the rotational actuator 740 to enable the angular position of the sensing assembly 710 around the axis of rotation of the shaft 730, by monitoring the output from the rotational encoder 760. In general, the axis of rotation of the sensing assembly 710 is configured to pass through the geometric centre of a sensing region 100 comprised in the sensing assembly 710. The specific arrangement shown schematically in FIG. 9 is exemplary, and it will be appreciated that in some embodiments, the arrangement may be configured differently. For example, the output shaft 750 of the rotational actuator 740 may be mounted to the sensing assembly 710 without any gearing or pulley arrangement interposed between the output shaft 750 and the sensing assembly 710. A rotating dosimeter assembly may be used to enable a controller 600 to collect and reconstruct signals for a plurality of different scintillation fibre orientations, according to approaches set out further herein. It may be considered advantageous to rotate the sensing assembly 710 during characterisation of a treatment plan to avoid radiation beams passing through one or more photodetectors.

As set out further herein, one use of a dosimeter 10 in accordance with the present disclosure is to validate a treatment plan for an IMTS or particle therapy treatment, where said treatment plan comprises directing one or more beams of radiation at a treatment region within a patient. The treatment plan may comprise directing multiple beams at the treatment region, either simultaneously, or at different times, and optionally modulating the intensity of the beam(s) to seek to deliver a predetermined radiation dose over a predetermined spatial distribution in the patient. The treatment plan will generally be designed to seek to deliver the maximal radiation dose at the site of a tumour or lesion (i.e. the treatment site), and to minimize the radiation dose in healthy tissues surrounding the treatment site. A dosimeter according to the present disclosure may be used to validate the spatial distribution of the received radiation dose, by obtaining a 3D reconstruction of the radiation dose within the sensing region of the dosimeter (i.e. a dose map), showing the spatial distribution of the radiation dose, and comparing it with the predicted spatial distribution of the radiation dose for the treatment plan as determined, for example, by mathematical modelling based on CT or MRI imagery of the patient's body.

In use, the dosimeter 10 is placed in a position relative to the apparatus used to deliver the radiation dose such that the sensing region 100 of the dosimeter is aligned with the spatial region in which a radiation dose is to be delivered. For example, the dosimeter may be mounted on an actuated treatment table on which the patient is to be positioned during the delivery of the treatment plan. Fiducial markers on the dosimeter 10 (not shown), positioned at known locations relative to the sensing region of the dosimeter, may be used to align the dosimeter 10 such that the sensing region 100 is spatially aligned with (e.g. fully or partially includes) the volumetric region in which the treatment site of the patient is to be positioned during the delivery of the treatment plan. The size and shape of the sensing region 100 may be configured so as to encompass a volume corresponding to the treatment site and surrounding tissue, and may in some instances be configured to be similar in size and/or shape to an entire part of the body which is to be treated (e.g. a head, a torso or a limb). The treatment plan to be applied to the patient is then applied to the sensing region 100 of the dosimeter 10, by directing one or more beams of radiation (e.g. one or more higher-energy proton pencil beams) into the sensing region 100, with the direction(s) of entry of the beam(s) and the beam parameters (e.g. accelerating potential) modulated according to the treatment plan. During the treatment plan, the dosimeter 10 is controlled by the controller 600 to collect signals from the ones of the plurality of photodetector regions comprised in the dosimeter according to approaches as set out further herein. Signals may be collected from the photodetector regions on a continuous basis. For example, the photodetector regions may comprise sensor pixels of one or more CMOS photodetectors, with a frame rate of, for example, 30 frames per second for the array of sensor pixels, such that every 33 milliseconds a signal is received by the controller from each sensor pixel, being proportional to the photon count at the sensor pixel, received from one or more scintillation fibres coupled to said sensor pixel. The controller may read signals from the photodetector according to a rolling shutter scheme. The signals received from each photodetector region (e.g. one or more sensor pixels) may be integrated by the controller 600 for an integrating period which may be equal to or shorter than the duration of the treatment plan. In the case of a non-rotating dosimeter 100 (i.e. not comprising a rotational actuator 740 to rotate the sensing region 100 based on inputs from the controller 600), the integrated signal over the treatment plan for each photodetector region may be used as the input for the reconstruction of a dose map (following an approach as set out further herein), such that the dose map is representative of the entire dose received in the sensing region 100 during delivery of the treatment plan. In other examples, the signals received from each photodetector region may be integrated by the controller for an integrating period which is shorter than the duration of the treatment plan. The treatment plan (or a subset of it) may be repeated a plurality of times, with the sensing assembly of the dosimeter being rotated between each repeat of the treatment plan (or subset) so that the controller can receive a set of signals from photodetector regions coupled to respective sets of scintillation fibres extending through the sensing region substantially parallel to a different direction for each repeat of the treatment plan. Data representing the signals acquired in this manner may be used to reconstruct a dose map using one of the reconstruction approaches set out further herein (such as, for example, that described in relation to FIG. 8 for orthogonal scintillation fibre orientations, and/or a filtered back-projection or iterative reconstruction approach for either orthogonal or non-orthogonal fibre orientations).

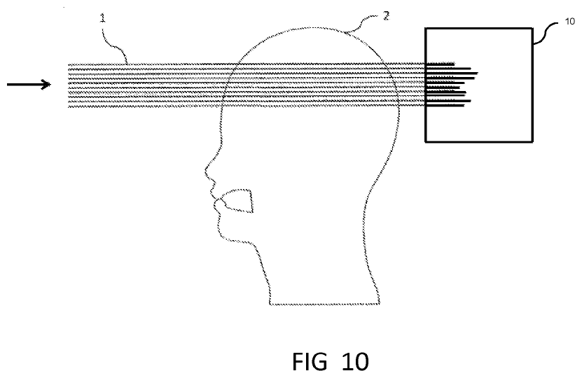

A further use of a dosimeter according to the present disclosure is in proton radiography or tomography protocols, in which multiple proton pencil-beams, comprising protons of a high enough energy to pass right though the object to be imaged, may be detected in the dosimeter described above. Due to the spatial variations in the stopping power of the tissues encountered by the proton beams along their separate paths, the protons emerge having different residual ranges. This information can be found by recording the depth of penetration of each beam in the dosimeter as shown in FIG. 10. This information can be used to construct a proton-radiograph of that region which is to be treated by proton-therapy.

A site of interest in an object to be imaged in this manner may be the whole or part of a human or animal body, or any other object which it is of interest to characterise. FIG. 10 schematically shows an arrangement in which a proton source (not shown) is positioned to direct one or more pencil beams of higher-energy protons 1 through a part of a human body 2 (the head in this example). A dosimeter 10, as described herein, is positioned on the opposite side of the part to be imaged, coincident with the path of the proton beam 1. The dosimeter 10 in this configuration may be considered to act as a proton detector. When proton beam 1 is passed through the part to be imaged, protons which pass through the part to be imaged (i.e. do not come to rest within it) can be intercepted by the dosimeter 10 for detection according to approaches set out further herein (i.e. by detecting, using one or more photodetectors, photon signals from scintillation events within the dosimeter 10). The energy characteristics of a ‘transmitted’ beam of photons which has passed through the part to be imaged, will be a function of the initial energy characteristics of the incident beam, and the proton absorption and/or scattering characteristic of the materials along the proton beam path through the part to be imaged. Accordingly, the residual proton energy at a position x on a given path line between the proton source and the dosimeter 10, as a function of the initial proton energy (i.e. the energy drop), can be considered to represent a line integral of proton attenuation along the path between the proton source and position x. The residual energy of protons on a given line path through the part to be imaged can be characterised by a dosimeter 10 according to the present disclosure.

FIG. 10 shows a number of notional parallel proton beam paths comprised in beam 1 (e.g. a pencil beam) along which photons have passed through the part to be imaged 2, and have been intercepted by the dosimeter 10. As a consequence of the Bragg characteristics of protons, the distance of proton penetration into the dosimeter along a given path is a function of the attenuating properties of the dosimeter material, and the residual energy of the protons travelling along said path. The more energy the residual protons have, the further they will penetrate into the dosimeter 10 (i.e. into the sensing region, as described further herein). Assuming the proton attenuating properties of the dosimeter are effectively homogenous, the distance of proton penetration along a given beam path (as quantified by the deposited energy distribution along the portion of said path which is within the sensing region of the dosimeter 10) can be used along with the initial beam energy to quantify the line integral of proton attenuation along said path through the part to be imaged. In this manner, the dosimeter can be used (in accordance with the approaches set out further herein, i.e. static or rotating configurations) to characterise the energy of a transmitted proton beam in a spatially resolved manner. By using information on the beam geometry and dosimeter position, a radiograph can thus be reconstructed where pixel intensity values represent line integrals of proton attenuation through the part to be imaged. If the proton source and dosimeter 10 are moved to angular different positions around the part to be imaged, with the proton attenuation of the proton beam 1 characterised by the dosimeter 10 for each angular position, a resulting set of proton radiographs can be used to reconstruct a 3D map of proton attenuation within the part to be imaged using tomographic approaches known to the person skilled in the art. If a patient/object to be imaged is rotated within a proton-beam, a 3-D image of the tissue structure in the region of the patient through which the beam passes can be reconstructed based on radiographs obtained via the dosimeter, using techniques analogous to X-ray CT imaging and known to the skilled in the art (for example filtered back-projection or algebraic reconstruction). Such proton radiography/tomography approaches may be used to acquire image data representing a treatment site of a patient for use in the treatment planning phase of radiotherapy treatment, and/or may be used to validate during proton therapy that the beam energy is not too high (by validating that protons are not being transmitted through the patient). It will be appreciated these techniques may be used for imaging using other radiation types which display similar Bragg characteristics to protons.

Accordingly there has been described embodiments of a dosimeter for characterising a spatial distribution of a radiation dose in a sensing region, the dosimeter comprising; a plurality of scintillation fibres extending substantially parallel to a first direction in the sensing region and arranged in a two-dimensional array in a plane perpendicular to the first direction; and a photodetector comprising a plurality of photodetector regions coupled to respective ones of the plurality of scintillation fibres so as to generate signals for respective ones of the photodetector regions in response to radiation interaction events in corresponding ones of the scintillation fibres; further comprising a controller arranged to receive the signals from the photodetector regions and to determine a spatial distribution of a radiation dose in the sensing region based on the extent to which the signals from the plurality of photodetector regions indicate there have been radiation interaction events in different ones of the plurality of scintillation fibres.

The various embodiments described herein are presented only to assist in understanding and teaching the claimed features. These embodiments are provided as a representative sample of embodiments only, and are not exhaustive and/or exclusive.

It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A dosimeter for characterising a spatial distribution of a radiation dose in a sensing region, the dosimeter comprising;
a plurality of scintillation fibres extending substantially parallel to a first direction in the sensing region and arranged in a two-dimensional array in a plane perpendicular to the first direction, wherein the radiation absorption properties of the plurality of scintillation fibres are configured to approximate the radiation absorption properties of human body tissue; and
a photodetector comprising a plurality of photodetector regions coupled to respective ones of the plurality of scintillation fibres so as to generate signals for respective ones of the photodetector regions in response to radiation interaction events in corresponding ones of the scintillation fibres;
further comprising a controller arranged to receive the signals from the photodetector regions and to determine a spatial distribution of a radiation dose in the sensing region based on the extent to which the signals from the plurality of photodetector regions indicate there have been radiation interaction events in different ones of the plurality of scintillation fibres.

2. The dosimeter of claim 1, wherein a plurality of parallel scintillation fibres are arranged in a plurality of stacked layers.

3. The dosimeter of claim 2, wherein each layer of scintillation fibres in the plurality of stacked layers comprises a pre-fabricated mat of scintillation fibres, wherein the scintillation fibres within each mat are oriented in the same direction, and the mats are bonded together to form the plurality of stacked layers.

4. The dosimeter of claim 1, wherein the scintillation fibres have a width of between 0.5 mm and 3 mm.

5. The dosimeter of claim 1, wherein the scintillation fibres have a square cross-section.

6. The dosimeter of claim 1, wherein a fibre optic faceplate is disposed between the plurality of scintillation fibres and the plurality of photodetector regions.

7. The dosimeter of claim 1, wherein a filter is disposed between the plurality of scintillation fibres and the plurality of photodetector regions.

8. The dosimeter of claim 1, wherein each of the plurality of scintillation fibres comprises a first end coupled to the photodetector and a second end distal to the first end, and wherein the dosimeter comprises one or more reflective elements arranged to reflect signals emitted from the second end of each of the scintillation fibres back towards the first end.

9. The dosimeter of claim 1, further comprising a drive mechanism arranged to rotate the plurality of scintillation fibres about a rotation axis perpendicular to the first direction such that signals can be generated by the plurality of photodetector regions for different orientations about the rotation axis of the plurality of scintillation fibres coupled to the photodetector regions.

10. The dosimeter of claim 1, wherein each of the plurality of photodetector regions is configured to integrate at least one parameter of signals received from one or more of the plurality of parallel scintillation fibres over a predetermined integrating period.

11. The dosimeter of claim 1, wherein the photodetector comprises a photodetector panel comprising an array of sensor pixels, and wherein each of the plurality of photodetector regions comprises one or more sensor pixels.

12. The dosimeter of claim 1, wherein the photodetector comprises a complementary metal oxide semiconductor panel.

13. The dosimeter of claim 1, wherein the photodetector is coupled to the plurality of parallel scintillation fibres such that a plurality of the photodetector regions is coupled to each of the plurality of parallel scintillation fibres.

14. The dosimeter of claim 1, further comprising a further plurality of scintillation fibres extending substantially parallel to a second direction in the sensing region and arranged in a two-dimensional array in a plane perpendicular to the second direction; and
a plurality of photodetector regions coupled to respective ones of the further plurality of scintillation fibres so as to generate signals for respective ones of the photodetector regions in response to radiation interaction events in corresponding ones of the further plurality of scintillation fibres, and
wherein the first direction is different to the second direction.

15. The dosimeter of claim 14, wherein the plurality of vertically stacked planes comprises planes of scintillation fibres oriented in the first direction, interleaved with planes of scintillation fibres oriented in the second direction.

16. The dosimeter of claim 1, wherein the dosimeter comprises a stack of scintillation fibre carriers, wherein each scintillation fibre carrier comprises a plane of scintillation fibres oriented in the first direction.

17. The dosimeter of claim 16, wherein each scintillation fibre carrier further comprises a plane of scintillation fibres oriented in the second direction

18. The dosimeter of claim 14, wherein the first direction is orthogonal to the second direction.

19. The dosimeter of claim 1 further comprising a controller configured to determine a spatial distribution of a radiation dose in the sensing region by applying a reconstruction algorithm to data representing signals collected from the plurality of photodetector regions, wherein the data comprise signals collected from the plurality photodetector regions when the plurality of scintillation fibres are oriented in a first orientation, and signals collected from the plurality photodetector regions when the plurality of scintillation fibres are oriented in a second, different orientation.

20. A method of characterising a spatial distribution of a radiation dose in a sensing region of a dosimeter comprising a plurality of scintillation fibres extending substantially parallel to a first direction in the sensing region and arranged in a two-dimensional array in a plane perpendicular to the first direction, wherein the radiation absorption properties of the plurality of scintillation fibres are configured to approximate the radiation absorption properties of human body tissue; a photodetector comprising a plurality of photodetector regions coupled to respective ones of the plurality of scintillation fibres so as to generate signals for respective ones of the photodetector regions in response to radiation interaction events in corresponding ones of the scintillation fibres; and a controller arranged to receive the signals from the photodetector regions; wherein the method comprises the steps of:
receiving, by the controller, signals generated for respective ones of the photodetector regions in response to radiation interaction events in corresponding ones of the scintillation fibres; and
determining, by the controller, a spatial distribution of a radiation dose in the sensing region based on the extent to which the signals from the plurality of photodetector indicate there have been radiation interaction events in different ones of the scintillation fibres.
